(19) United States
(12) Patent Application Publication
(10) Pub. No.: US 2017/0264651 A1
(43) Pub. Date: Sep. 14, 2017

(54) Communication System

(71) Applicant: Microsoft Technology Licensing, LLC, Redmond, WA (US)

(72) Inventors: Brandon V. Taylor, Mercer Island, WA (US); Brad C. Stevenson, Redmond, WA (US); Joseph T. Wyman, Seattle, WA (US)

(21) Appl. No.: 15/064,458

(22) Filed: Mar. 8, 2016

(51) Int. Cl. H04L 29/06; H04L 29/08

(52) U.S. Cl. CPC H04L 65/1083; H04L 65/601; H04L 67/1095

(57) ABSTRACT

There is provided a method comprising: causing received image and/or audio data associated with an audio-visual call to be played-out via a user interface; receiving, during the audio-visual call, an instruction to store received image and/or audio data associated with the audio-visual call; and storing image and/or audio data played-out prior to receipt of the instruction in response to the received instruction.

### BACKGROUND

A conversation visualisation environment is an environment operating on a device that causes graphical content associated with a communication exchange between users to be rendered on a display to one of the users performing the exchange. A conversation visualisation environment is associated with a respective messaging application, which coordinates the communication exchange between users. Conversation visualisation environments allow conversation participants to exchange communications in accordance with a variety of conversation modalities. For example, participants may engage in video exchanges, voice calls, instant messaging, white board presentations, and desktop views of other modes.

As the feasibility of exchanging conversation communications by way of a variety of conversation modalities has increased, so too have the technologies with which participants may engage in a video call using traditional desktop or laptop computers, tablets, phablets, mobile phones, gaming systems, dedicated conversation systems, or any other suitable communication device. Different architectures can be employed to deliver conversation visualisation environments, including centrally managed and peer-to-peer architectures.

Many conversation visualisation environments provide features that can enhance the communication experience between at least two users. One such feature allows a user to record video data during an audio-visual call for later editing and/or playback. This allows a user to playback parts of the conversation at a later time.

### SUMMARY

The inventors have realised that a user wishing to record video data during an audio-visual call may only realise that they want to record the video data when they see an event that they would like to capture. At this point, initiating a record function will not capture the entire event, as part of it has already happened. A way to overcome this would be to record the entire video data/stream associated with the call and to later edit the recorded video to keep the bits the user wants to. However, in addition to being memory intensive (particularly for multi-party calls), such an approach is laborious to the user, as they have to manually go through the recorded video data to edit it. The following aims to address at least one of these issues.

According to a first aspect, there is provided a method comprising: causing received image and/or audio data associated with an audio-visual call to be played-out via a user interface; receiving, during the audio-visual call, an instruction to store received image and/or audio data associated with the audio-visual call; and storing image and/or audio data played-out prior to receipt of the instruction in response to the received instruction.

According to a second aspect, there is provided a user terminal comprising: at least one processor; and at least one memory comprising code that, when executed on the at least one processor, causes the user terminal to: cause received image and/or audio data associated with an audio-visual call to be played-out via a user interface; receive, during the audio-visual call, an instruction to store received image and/or audio data associated with the audio-visual call; and store image and/or audio data played-out prior to receipt of the instruction in response to the received instruction.

According to the above, there is further provided a computer program comprising code means adapted to cause performing of the steps of any of claims 1 to 18 when the program is run on data processing apparatus.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user terminal;

FIG. 3 is a flow chart illustrating potential actions by a user terminal; and

FIGS. 4A to 4C depict conversation visualisation environments that may be depicted on a display screen of the user terminal of FIG. 3.

### DESCRIPTION

The following relates to a user communicating with at least one other user, using respective user terminals, in an audio-visual call. The audio-visual call may comprise video (or other image) data, such as video data representative of a current state of one of the users on the call, e.g. a real-time live video stream. The audio-visual call also comprises audio data associated with the image data. During the call, one of the users identifies an event in the played-out image data and/or the played out audio data that he wishes to record and so inputs an instruction into his respective user terminal to record that event. The user terminal, in response to this instruction, retrieves the image data and/or the audio data that was played-out prior to receipt of the instruction and stores the retrieved image data and/or audio in at least one predetermined form (such as a video, an animated gif, a still image, etc.). This allows a user to store video data relating to an event that has already happened.

The retrieved and stored data may be image data, audio data or a combination of image data with its associated audio data. The term associated audio data is used here to indicate audio data that is played-out concurrently with the respective image data. To ensure clarity, throughout the following description the embodiments will be described in terms of being applied to image data and/or video data. However, such techniques may be similarly applied to audio data and to associated image data and audio data (i.e. image data and audio data that is played out simultaneously), depending on the implementation.

The instruction may further cause video data played-out immediately subsequent to the received instruction to be stored with the retrieved video data (e.g. as part of the same data item). The length of time covered by the video data stored in response to the received instruction may be set to a predetermined length. This means that the instruction causes video data to be stored that is played-out during a predetermined time interval, the predetermined time interval being set around the time of receipt of the instruction. The division between the prior-played-out video data and subsequently-played-out video data may be set by a user. For example, where the time interval is 10 seconds, the division may be set up so that the video data is saved in any of the following (non-exhaustive) ways: the immediately preceding 10 seconds; the immediately preceding 7 seconds and the immediately subsequent 3 seconds; the immediately preceding 5 seconds and the immediately subsequent 5 seconds; and the immediately preceding 2 seconds and the immediately subsequent 8 seconds.

The received video data may be kept for only a predetermined amount of time without receipt of said instruction before being discarded. In other words, if the above-mentioned instruction had not been received, the video data would have been deleted after a predetermined time without storing it in a more permanent fashion. Thus, the above-described user terminal may be said to only be able to retrieve, for storing, video data in response to the received instruction that was played-out within a preset time period of the time the instruction is received. The preset time period may be the same, or smaller than, the predetermined amount of time. This mechanism of keeping video data for only a predetermined amount of time before discarding without receipt of a recording instruction, allows for the user terminal to free up memory resources, as older (presumed unwanted) video data is deleted. Therefore the entire received video data for the call is not recorded for later editing. Moreover, only when a user indicates an interest to record a particular time period is the video data stored in a more permanent fashion, which further conserves resources.

In order that the environment in which the present system may operate be understood, by way of example only, we describe a potential communication system and user terminal into which the subject-matter of the present application may be put into effect. It is understood that the exact layout of this network is not limiting.

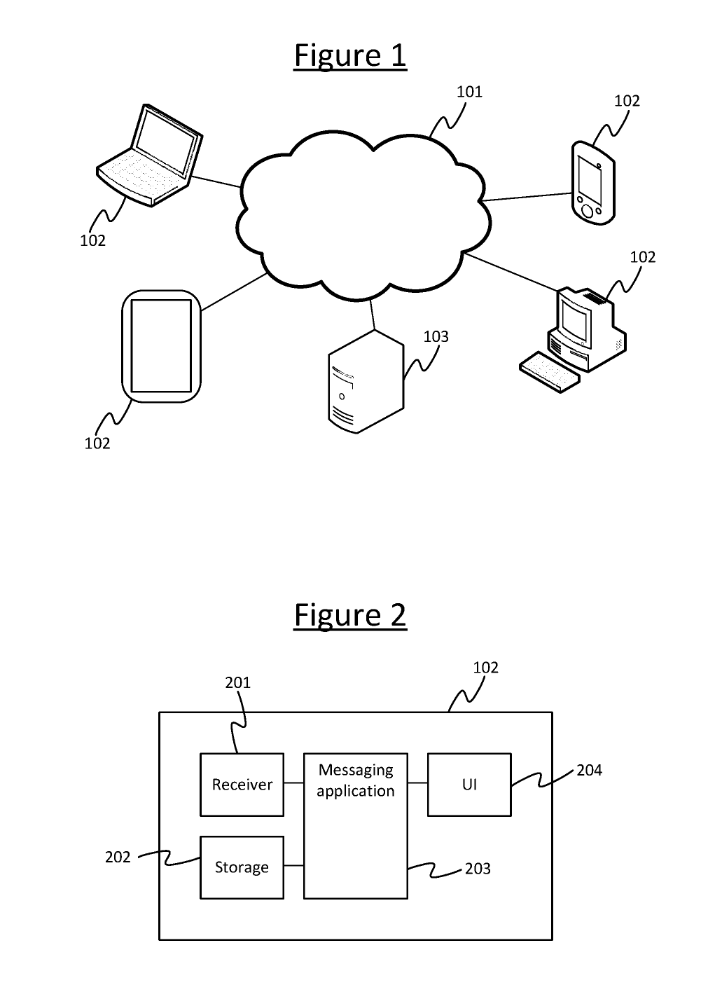

FIG. 1 shows an example of a communication system in which the teachings of the present disclosure may be implemented. The system comprises a communication medium 101, in embodiments a communication network such as a packet-based network, for example comprising the Internet and/or a mobile cellular network (e.g. 3GPP network). The system further comprises a plurality of user terminals 102, each operable to connect to the network 101 via a wired and/or wireless connection. For example, each of the user terminals may comprise a smartphone, tablet, laptop computer or desktop computer. In embodiments, the system also comprises a network apparatus 103 connected to the network 101. It is understood, however, that a network apparatus may not be used in certain circumstances, such as some peer-to-peer real-time communication protocols. The term network apparatus as used herein refers to a logical network apparatus, which may comprise one or more physical network apparatus units at one or more physical sites (i.e. the network apparatus 103 may or may not be distributed over multiple different geographic locations).

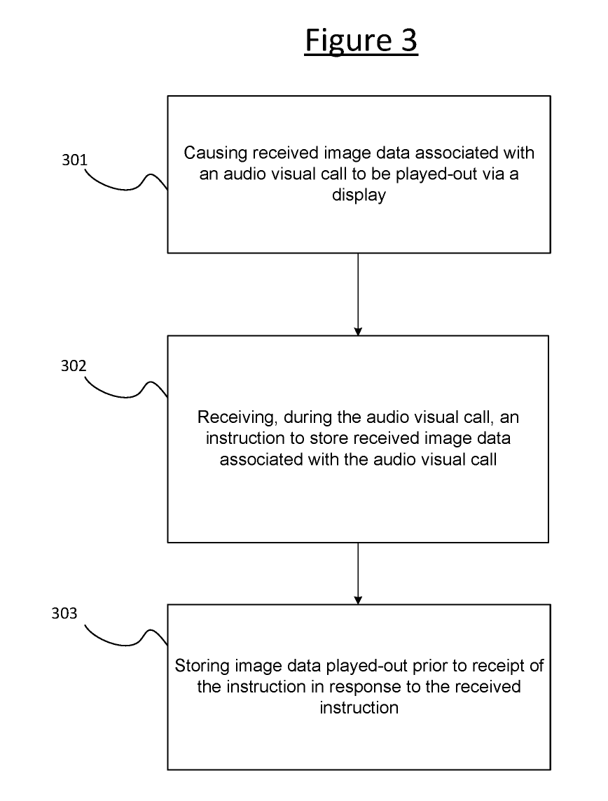

FIG. 2 shows an example of one of the user terminals 102 in accordance with embodiments disclosed herein. The user terminal 102 comprises a receiver 201 for receiving data from one or more others of the user terminals 102 over the communication medium 101, e.g. a network interface such as a wired or wireless modem for receiving data over the Internet or a 3GPP network. The user terminal 102 also comprises a non-volatile storage 202, i.e. non-volatile memory, comprising one or more internal or external non-volatile storage devices such as one or more hard-drives and/or one or more EEPROMs (sometimes also called flash memory). Further, the user terminal comprises a user interface 204 comprising at least one output to the user, e.g. a display such as a screen, and/or an audio output such as a speaker or headphone socket. The user interface 204 will typically also comprise at least one user input allowing a user to control the user terminal 102, for example a touch-screen, keyboard and/or mouse input.

Furthermore, the user terminal 102 comprises a messaging application 203, which is configured to receive messages from a complementary instance of the messaging application on another of the user terminals 102, or the network apparatus 103 (in which cases the messages may originate from a sending user terminal sending the messages via the network apparatus 103, and/or may originate from the network apparatus 103).

The messaging application is configured to receive the messages over the network 101 (or more generally the communication medium) via the receiver 201, and to store the received messages in the storage 202. For the purpose of the following discussion, the described user terminal 102 will be considered as the receiving (destination) user terminal, receiving the messages from one or more other, sending ones of the user terminals 102. Further, any of the following may be considered to be the entity immediately communicating with the receiver: as a router, a hub or some other type of access node located within the network 101. It will also be appreciated that the messaging application 203 receiving user terminal 102 may also be able to send messages in the other direction to the complementary instances of the application on the sending user terminals and/or network apparatus 103 (e.g. as part of the same conversation), also over the network 101 or other such communication medium.

The messaging application comprises code that, when executed on a processor, causes a display to render a conversation visualisation environment. The conversation visualisation environment is as described above, and provides a visual indication of events associated with audio-visual calls.

The messaging application may transmit audio and/or visual data using any one of a variety of communication protocols/codecs. For example, audio data may be streamed over a network using a protocol known Real-time Transport Protocol, RTP (as detailed in RFC 1889), which is an end-to-end protocol for streaming media. Control data associated with that may be formatted using a protocol known as Real-time Transport Control Protocol, RTCP (as detailed in RFC 3550). Session between different apparatuses may be set up using a protocol such as the Session Initiation Protocol, SIP.

The following discusses particular embodiments of the presently described system. It is understood that various modifications may be made within these embodiments without exceeding the scope of the claimed invention.

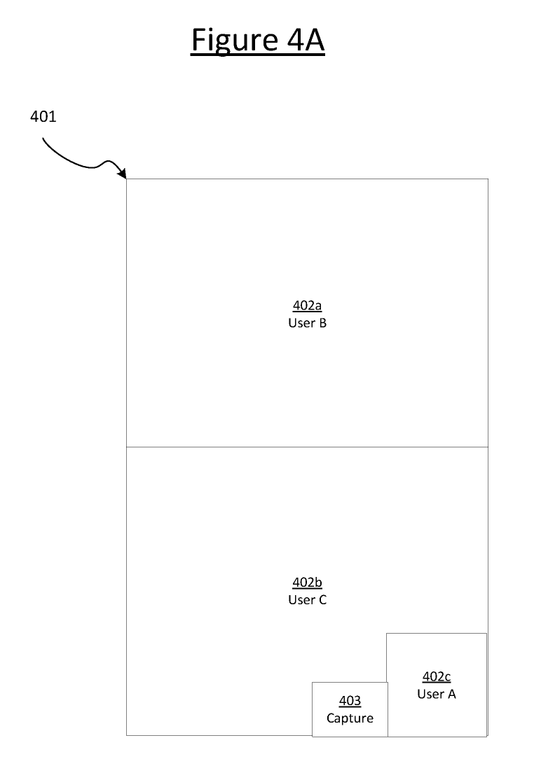

The following refers to the example of FIG. 3, which is a flow chart illustrating potential actions executed by a user terminal. The actions may be executed in response to the user terminal executing code on at least one processor of the user terminal.

At 301, the user terminal is configured to play-out image data associated with an audio-visual call. The audio-visual call is conducted between at least two participants using a messaging application. The played-out image data may be rendered in a conversation visualisation environment output via a display operatively connected to the user terminal. As mentioned above, the image data may be a live (i.e. real-time) video stream of at least one of the users participating in the audio-visual call. The image data may be video streams of both the user operating the user terminal in addition to at least one user participating in the audio-visual call. It may also be that a single user has multiple video streams (for example, where there are multiple cameras on a user terminal, each of which providing a separate video stream for play-out during the audio-visual call). A possible example of this is where a user terminal comprises both a front-facing camera (i.e. a camera configured to face towards the user when the user views the display of the user terminal) and a rear-facing camera (i.e. a camera configured to face away from a user when the user views the display of the user terminal). The image data may therefore be any (including both) of these multiple video streams (separate video streams for multiple users and separate video streams for a single user).

At 302, the user terminal is configured to receive, during the audio-visual call, an instruction to store image data. The instruction may be received via a user input. For example, the conversation visualisation environment may cause a selectable link to be displayed that, when selected, causes the instruction to be generated. The instruction is processed within the messaging application located on the user terminal. The image data may be associated with a single video stream of one user on the call, or be multiple streams relating to multiple users on the call. The instruction may indicate at least one particular stream for which image data should be stored, or may comprise no indication at all. Where no particular streams are identified, various saving options may be employed, depending on how the system is configured. For example, image data associated with all of the different users on the call may be saved, image data of the same type may be saved and/or only video streams that were being played out immediately before the instruction was generated may be saved. If multiple streams are stored in response to the instruction, this allows the user to avoid any latency issues in selecting which stream is to be stored.

At 303, in response to the received instruction, the user terminal is configured to store image data that was played-out prior to receipt of the instruction. In this respect, the user terminal is configured to cause a predetermined amount of image data to be transferred from a first memory location (such as a temporary cache) to a second memory location (such as a memory for storing gallery videos in the user terminal). In other words, receipt of the instruction causes image data that was played-out immediately prior to the receipt of the instruction to be transferred and/or copied from a temporary memory location to a more permanent memory location. An example of a temporary memory location is random access memory (RAM). An example of a more permanent memory location is read-only memory. The more permanent memory may be associated with the chat history profile of the user on the audio-visual call, and be located in a video gallery application or the like.

The first memory may be configured to only store image data for a predetermined amount of time. To this effect, the first memory may be a circular memory buffer. When a particular unit of image data (e.g. that defined by a frame) has been stored for the predetermined time, that particular unit of image data may be removed from the first memory without storing it in another location. For example, the first memory may store no more than 5 seconds of image data. In response to the received instruction, the 5 seconds of stored image data is retrieved for storing in the second memory location. To determine when data should be permanently removed from the first memory, the user terminal may employ a counter and the oldest data may be flushed out at every tick/transition of counter (or some other periodic interval). In addition or in the alternative, the units of image data may comprise time stamps or other indicia indicative of a time at which that image data was played-out and/or recorded (or an order in which the image data was recorded). The user terminal may use any of these time stamps and/or indicia to determine when to permanently remove image data stored in the first memory location. Unless an instruction to store data has been received in the preceding (predetermined) time period, this removed image data is not stored in a more permanent memory location: it is discarded.

In response to storing of image data in response to the instruction, the user terminal may be configured to cause a user display operatively connected to the user terminal to present an indication to the user that informs the user that the image data is being stored. This notification is displayed via the conversation visualisation environment. This notification may indicate how far back the stored image data relates. For example, where 5 seconds are stored, the indication may inform the user that the preceding 5 seconds of image data has been stored.

Image data received subsequent to the received instruction may also be stored with the prior-played-out image data. In other words, the user terminal may be configured to continue, for a predetermined time after the instruction is received, to store image data played-out subsequent to receipt of the instruction in the more permanent memory location. This data may be stored with the stored previously played-out image data as part of the same data item (e.g. as part of the same file). The amount of subsequent image data saved may also be indicated via the indication. In particular, the image of a timer may be present within the indication. The timer may count down a time for storing any subsequently played-out image data with the prior-played-image data, with the storing stopping when the timer hits zero. In this manner, the user viewing the conversation visualisation environment will know exactly how much image data has been stored in a more permanent location.

The user may continue to record data by selecting the selectable link again. This may either form a new data item (corresponding to the immediately previously played-out data and subsequently played-out data, such that there is some common image data between the new data item and the original data item) and/or continue to store video data being played-out subsequent to receipt of the instruction in the same data item as the original data item.

The received instruction could cause the received image data to be stored in any one of a number of different forms. For example, the image data may be stored as any of: a video, an animated gif, and a still image. Where the image data (or a part thereof) is stored as a video, the image data may be saved as a moji, which is a video clip that may be used in a text-based conversation in a conversation visualisation environment to express an emotion (similar to an emoticon/emoji). The moji may be accessible separately from other types of video data associated with the audio-visual call. For example, there may be provided a separate moji link in the conversation visualisation environment, selection of which causes mojis (or mojis and emoticons/emojis) to be displayed for selection. Selection of a particular moji causes that moji to be sent to another user in the text-based conversation in the conversation visualisation environment. The moji may be accessible in a plurality of different conversations in the conversation visualisation environment. In one embodiment, the image data may be saved in at least two of these forms, such that a single received instruction to record prior played-out image data causes the image data to be saved in multiple forms. It is useful if one of those forms is video data, as the other types of forms may be extracted from the saved video data. Therefore, in one example, the image data is saved at least as video data in the second memory location in response to the received instruction, and may be saved in other forms.

That the user terminal has received this instruction (and/or that the prior-played-out image data has been stored) may be indicated to other user(s) (operating other user terminals) on the audio-visual call. This notification may cause those other user(s) to likewise store the same image data that was stored in response to receipt of the instruction. To this effect, the notification may include a copy of the image data that was stored by the notifying user terminal and/or the notification may simply cause the other user terminal(s) to retrieve image data from their own respective temporary memory locations for storage in a more permanent respective memory location.

As mentioned above, the total image data that is stored in response to the received instruction may correspond to a preset interval of time. For example, receipt of the instruction may cause image data corresponding to 5 seconds to be stored, or may cause image data corresponding to 10 seconds to be stored, etc. The length of the preset interval of time may be set by a user of the user terminal or may be preprogrammed into the messaging application. Further, the stored image data may solely comprise image data that was played-out prior to receipt of the instruction, or may comprise both image data that was played-out prior to and subsequent to receipt of the instruction. The preset interval covers both of these options. The user may have the option of selecting the division in the preset interval between how much of the prior-played-out image data and how much of the subsequent played-out image data is stored (e.g. a 50/50 split, a 30/60 split, etc.). Alternatively, this division may be set by programming within the messaging application.

After storing the image data, the user may be presented with various options for editing the stored image data. For example, the user may be presented with the option of storing a copy of the stored image data in another form (e.g. to form an automated gif, and/or a static image). As mentioned above, where the image data (or a part thereof) is stored as a video, the image data may be saved as a moji, which is a video clip that may be used in a text-based conversation in a conversation visualisation environment to express an emotion (similar to an emoticon/emoji). The moji may be accessible separately from other types of video data associated with the audio-visual call. For example, there may be provided a separate moji link in the conversation visualisation environment, selection of which causes mojis (or mojis and emoticons/emojis) to be displayed for selection. Selection of a particular moji causes that moji to be sent to another user in the text-based conversation in the conversation visualisation environment. The moji may be accessible in a plurality of different conversations in the conversation visualisation environment. The user may be further presented with the option of applying various filters, or other processing tools to the image data. Example processing tools include superposition of graphical icons over the image data, modifications to the aspect ratio of objects identified within the image data, etc. The user may be provided with the option to share the stored image data. The option to share may apply to any of the original image data and the modified/processed image data, and the option may include individual selection of image data items.

The stored image data may be further stored as a data item with associated audio data. Associated audio data is audio data that was played-out synchronously with the image data. The audio data may be processed using known processing tools (e.g. to alter the pitch, etc.) The associated audio data may also be stored in response to the received instruction.

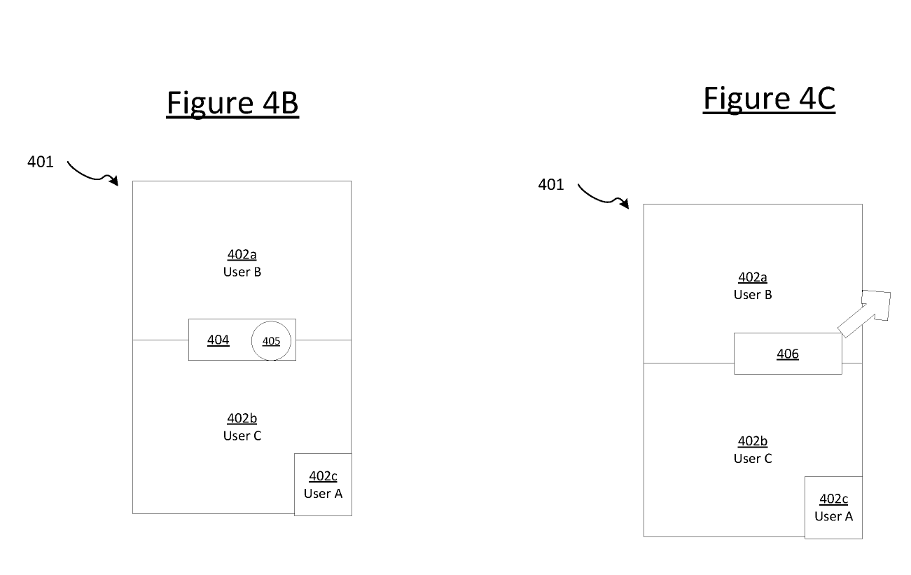

A particular example of the above-described techniques are described in relation to FIGS. 4A to 4C. In the example of FIGS. 4A to 4C, there are three users participating in the audio-visual call. However, it is understood that this is just used to provide an example and is not limiting.

FIGS. 4A to 4C relate to an example in which there are three users communicating on an audio-visual call via respective user terminals using a messaging application. The audio-visual call is visually depicted in a conversation visualisation environment of the messaging application shown via a display operatively connected to at least one of the user terminals. FIG. 4A depicts the conversation visualisation environment 401 of a first user (User A) on the call. As can be seen, the conversation visualisation environment renders (via a display) respective video streams of the other users on the call (Users B and C, 402a, 402b), as well as a video stream of User A 402c. The conversation visualisation environment further presents a selectable “capture” link 403. The capture link 403 may be displayed only when a dropdown box is activated in the conversation visualisation environment, or may be displayed without use of a dropdown box or the like. Although capture link 403 and the video stream of User A 402c are shown as superposed over other elements in the conversation visualisation environment 401, it is understood that this is not limiting.

If User A sees something in at least one of the video streams that he would like to record, s/he selects/activates the “capture” link 403 using a user input. This user input may be received by any suitable input mechanism, such as a mouse, a pressure exerted using an interactive display screen, a keyboard or the like.

On selection of the “capture” link 403, User A's user terminal is configured to cause the preceding x seconds of played-out video streams of all of the users to be retrieved from a local temporary cache and stored in a more permanent form of storage (such as in a gallery in User A's profile and/or a gallery associated with a chat history of the messaging application, which may be embodied locally on the user terminal itself or on the cloud). The number of seconds “x” may be set by a user, by the programming associated with the audio-visual call messaging application, or by a combination of the two.

The conversation visualisation environment 401 immediately after selecting the “capture” link is shown in FIG. 4B. User A's conversation visualisation environment is caused to present a graphical representation 404 to User A that indicates that at least the preceding x seconds of played-out video streams have been saved. The graphical representation further includes a timer 405 depicting a countdown. The timer countdown is indicative of the length of time (y seconds) of video stream that is played-out subsequent to the activation/selection of the capture link that is also being saved with the preceding x seconds of played-out video streams (i.e. that is being saved as part of the same data item in the more permanent memory location). The preset interval mentioned above in relation to FIG. 3 is therefore x plus y seconds long.

FIG. 4C depicts the conversation visualisation environment immediately after the timer expires. A notification 406 is presented in the conversation visualisation environment that indicates that a data item (e.g. a video) corresponding to the x and y seconds of played-out video stream is being saved into a particular memory location on the user's profile (e.g., as mentioned above, a gallery accessible to the software used to present the conversation visualisation environment). This notification may present further options 407 to the user to edit the recorded/stored data item and/or to store a copy of the data item in at least one other form (e.g. an animated gif, and/or still image) and/or to share this data item with another user on the call. These options may also or in the alternative be presented to the user at a later time. Example later times include when the call has finished (as part of a summary of the call) and when the user subsequently accesses the location in which the data item is stored.

The data item is referenced as being a single data item in the above. In other words, all of the video streams are saved as part of the same data item and may all be displayed on later play-out of the data item. However, it is understood that all of the data streams may be saved separately. If the video streams are saved as separately accessible video streams, it is understood that these may be saved in a storage location using a suitable indexing form/naming system to indicate that these video streams were saved at the same time e.g. in an appropriate directory structure. The messaging application may be configured to provide an appropriate name for the stored data to enable the user to identify it (although the user may subsequently rename it). It is useful for the messaging application to automatically name the file using an appropriate naming convention and/or in an appropriate location as it saves the user from having to concentrate on this when they are also participating in the call.

The audio-visual call may have an associated chat history, comprising items such as instant messaging conversations, details on files exchanged through the conversational visualisation environment, details regarding when various users joined and/or left the call, etc. The data item(s) may be stored in a similar way to those in the chat history of the conversational visualisation environment that is associated with that audio-visual call. For example, the data item(s) may be saved to the same memory address space as the associated chat history items. Further, both the chat history items and the data item(s) may comprise consistent timestamps that indicate when in the chat history each item occurred. These time stamps may be relative within the chat history, or refer to some absolute system time (e.g. of a network entity and/or of a user terminal). These time stamps may be used for rendering a representation of the data item(s) and the chat history items on a display of a user terminal (e.g. a user terminal performing the claimed method and/or other user terminals participating in the audio-visual call).

Also in the above, the actual video streams to be stored in a more permanent memory location may be determined in a number of ways. For example, particular video streams to be recorded may be selected by the user that activates/selects the capture link 403 or similar. To this effect, there may be a separate capture link for each video and/or a drop down box from the capture link to select a particular user participating in the call. The actual video streams to be stored may be determined via programming within the messaging application. For example, the programming may indicate that all received video streams should be stored in a more permanent memory location, the programming may indicate that only those video streams being rendered when the instruction is received should be stored in a more permanent memory location, or the programming may indicate that only those image data being received as video data may be stored in a more permanent memory location.

When User A selects the “capture” link 403, the other users (Users B and C) may also be informed that User A has selected this link. This may be done at a variety of times. For example, Users B and C may be notified that A has selected the “capture” link almost immediately in response to User A selecting that link. Alternatively, Users B and C may only be notified after the entire data item has been created at the end of the process initiated by selecting the “capture” link (either automatically or in response to User A sharing the stored data item). The notification may also cause Users B and C to save similar and/or identical data items in respective storage locations on profiles associated with Users B and C. This may be done either by causing the user terminals of Users B and C being used to perform the audio-visual call to perform the same operations as the user terminal of User A (e.g. retrieving the preceding x seconds of played-out video streams and storing with the subsequent y seconds of played-out video stream) and/or by providing to Users B and C a copy of the data item created/stored by the user terminal of User A for storage.

In all of the above embodiments, the user may be presented with an option to play-back the stored data item and/or the modified stored data item. The play-back of the stored data item and/or the modified stored data item may be automatic (e.g. if the stored and/or modified stored data item is an animated gif, this may be automatically played-out as a preview when rendered on a display). The user may be further presented with an option to share the stored data item and/or the modified stored data item. The sharing may be performed using the messaging application or via another messaging application operative on the device (e.g. via email, social media accounts, etc.). The sharing may be performed with at least one of the users participating on the call, and/or may be to any other user or website.

Although in the above, reference has been made to retrieving the prior-played-out image data from a local cache/temporary memory of the user equipment, it is understood that this prior-played-out image data may instead be located on a network-based server entity. The network-based server entity may be coordinating the audio-visual call between the different user terminals. This may be useful in that the user terminals do not have to store any played-out image data (even temporarily), but may increase the overhead transmission in the network.

In the above, the term “prior-played-out image data” and the like has been used to denote image data that was played-out via the display of the user terminal (by the conversation visualisation environment) before the instruction to record image data was received. Similarly, the term “subsequent played-out image data” and the like has been used to denote image data that was played-out via the display of the user terminal (by the conversation visualisation environment) after the instruction to record image data was received.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

According to the above, there is provided a method comprising: causing received image and/or audio data associated with an audio-visual call to be played-out via a user interface; receiving, during the audio-visual call, an instruction to store received image and/or audio data associated with the audio-visual call; and storing image and/or audio data played-out prior to receipt of the instruction in response to the received instruction.

Said instruction may cause a predetermined amount of image and/or audio data to be transferred from a first memory location to a second memory location. The second memory location may be a more permanent memory location than the first memory location.

Said instruction may cause the image data to be stored as any of: a video, an animated gif, and a still image. Said instruction may cause the image data to be stored as a video and any of: an animated gif, and a still image.

In response to said storing, the method may further comprise: causing a notification to be presented via a user display indicating that image and/or audio data currently being played out is being stored in response to the received instruction relates.

In response to said storing, the method may further comprise: sending a notification to a user terminal associated with the received image and/or audio data indicating that said image and/or audio data has been stored. Said sending may further comprise sending a copy of the stored image and/or audio data for rendering via a user interface of said user terminal.

The method may further comprise: continuing, for a predetermined time after the instruction is received, to store image and/or audio data played-out subsequent to receipt of the instruction as part of the same data item as the image and/or audio data played-out prior to receipt of the instruction.

Said instruction may be received via a user input.

The total amount of image and/or user data played-out prior to receipt of the instruction that is stored in response to the instruction may be set by a user.

The received image and/or audio data may relate to multiple audio-visual streams associated with the audio-visual call. The instruction may identify at least one of the audio-visual image streams. The instruction may cause image and/or audio data of multiple audio-visual streams associated with the audio-visual call that was played-out prior to receipt of the instruction to be stored. The instruction may cause said image and/or audio data of multiple audio-visual streams to be stored as part of the same data item.

The method may further comprise: causing a display to present an option to modify said stored image and/or audio data.

The method may further comprise: causing a display to present an option to share said stored image and/or audio data with another user.

The method may further comprise storing both image data and said audio data as different data items in response to the received instruction.

According to the above, there is further provided a user terminal comprising: at least one processor; and at least one memory comprising code that, when executed on the at least one processor, causes the user terminal to: cause received image and/or audio data associated with an audio-visual call to be played-out via a user interface; receive, during the audio-visual call, an instruction to store received image and/or audio data associated with the audio-visual call; and store image and/or audio data played-out prior to receipt of the instruction in response to the received instruction.

According to the above, there is further provided a computer program comprising code means adapted to cause performing of the steps of any of claims 1 to 18 when the program is run on data processing apparatus.

According to the above, there is provided a user terminal comprising: means for causing received image and/or audio data associated with an audio-visual call to be played-out via a user interface; means for receiving, during the audio-visual call, an instruction to store received image and/or audio data associated with the audio-visual call; and means for storing image and/or audio data played-out prior to receipt of the instruction in response to the received instruction.

1. A method comprising:
causing received image and/or audio data associated with an audio-visual call to be played-out via a user interface;
receiving, during the audio-visual call, an instruction to store received image and/or audio data associated with the audio-visual call; and
storing image and/or audio data played-out prior to receipt of the instruction in response to the received instruction.

2. A method as claimed in claim 1, wherein said instruction causes a predetermined amount of image and/or audio data to be transferred from a first memory location to a second memory location.

3. A method as claimed in claim 2, wherein the second memory location is a more permanent memory location than the first memory location.

4. A method as claimed in claim 1, wherein said instruction causes the image data to be stored as any of: a video, an animated gif, and a still image.

5. A method as claimed in claim 4, wherein said instruction causes the image data to be stored as a video and any of: an animated gif, and a still image.

6. A method as claimed in claim 1, wherein in response to said storing, the method further comprises:
causing a notification to be presented via a user display indicating that image and/or audio data currently being played out is being stored in response to the received instruction relates.

7. A method as claimed in claim 1, wherein in response to said storing, the method further comprises:
sending a notification to a user terminal associated with the received image and/or audio data indicating that said image and/or audio data has been stored.

8. A method as claimed in claim 7, wherein said sending further comprises sending a copy of the stored image and/or audio data for rendering via a user interface of said user terminal.

9. A method as claimed in claim 1, further comprising:
continuing, for a predetermined time after the instruction is received, to store image and/or audio data played-out subsequent to receipt of the instruction as part of the same data item as the image and/or audio data played-out prior to receipt of the instruction.

10. A method as claimed in claim 1, wherein said instruction is received via a user input.

11. A method as claimed in claim 1, wherein the total amount of image and/or user data played-out prior to receipt of the instruction that is stored in response to the instruction is set by a user.

12. A method as claimed in claim 1, wherein the received image and/or audio data relates to multiple audio-visual streams associated with the audio-visual call.

13. A method as claimed in claim 12, wherein the instruction identifies at least one of the audio-visual image streams.

14. A method as claimed in claim 12, wherein the instruction causes image and/or audio data of multiple audio-visual streams associated with the audio-visual call that was played-out prior to receipt of the instruction to be stored.

15. A method as claimed in claim 14, wherein the instruction causes said image and/or audio data of multiple audio-visual streams to be stored as part of the same data item.

16. A method as claimed in claim 1, further comprising:
causing a display to present an option to modify said stored image and/or audio data.

17. A method as claimed in claim 1, further comprising:
causing a display to present an option to share said stored image and/or audio data with another user.

18. A method as claimed in claim 1, further comprising storing both image data and said audio data as different data items in response to the received instruction.

19. A user terminal comprising:
at least one processor; and
at least one memory comprising code that, when executed on the at least one processor, causes the user terminal to:
cause received image and/or audio data associated with an audio-visual call to be played-out via a user interface;
receive, during the audio-visual call, an instruction to store received image and/or audio data associated with the audio-visual call; and
store image and/or audio data played-out prior to receipt of the instruction in response to the received instruction.

20. A computer-readable storage medium storing instructions that are executable by one or more processors to perform operations comprising:
causing received image and/or audio data associated with an audio-visual call to be played-out via a user interface;
receiving, during the audio-visual call, an instruction to store received image and/or audio data associated with the audio-visual call; and
storing image and/or audio data played-out prior to receipt of the instruction in response to the received instruction.
